(19) United States
(12) Patent Application Publication
(10) Pub. No.: US 2019/0393513 A1
(43) Pub. Date: Dec. 26, 2019

(54) ELECTRODE AND LITHIUM ION BATTERY

(71) Applicant: Ningde Amperex Technology Limited, Ningde (CN)

(72) Inventors: Tingling Lei, Ningde (CN); Zhifang Dai, Ningde (CN); Xinghua Tao, Ningde (CN); Hai Long, Ningde (CN)

(21) Appl. No.: 16/239,496

(22) Filed: Jan. 3, 2019

(30) Foreign Application Priority Data
Jun. 26, 2018 (CN) 201810672773.2

(51) Int. Cl. H01M 4/78; H01M 10/0525; H01M 4/13; H01M 2/34

(52) U.S. Cl. CPC H01M 4/78; H01M 10/0525; H01M 2004/025; H01M 2/34; H01M 4/13

(57) ABSTRACT

The present application provides an electrode and a lithium ion battery. The electrode includes a current collector, at least one surface of the current collector is coated with a first coating layer of the first active material; wherein the first coating layer includes at least one through hole, and the at least one through hole has a cross-sectional area of 1% to 20% of a cross-sectional area of the first coating layer. In the present application, by forming a first coating layer including at least one through hole on at least one surface of the current collector, and by providing a second coating layer on the first coating layer, the second coating layer may be connected to the current collector through the through hole, and the safety performance of the lithium-ion battery is improved.

### CROSS-REFERENCE TO RELATED APPLICATION

This application claims priority to and benefits of Chinese Patent Application Serial No. 201810672773.2, filed with the State Intellectual Property Office of P. R. China on Jun. 26, 2018, and the entire content of which is incorporated herein by reference.

### FIELD OF THE APPLICATION

The present application relates to the field of battery, in particular, to an electrode and a lithium ion battery.

### BACKGROUND OF THE APPLICATION

With the rapid development of technology, lithium-ion batteries have been widely used in various fields of life, and their safety issues have received more and more attention. Lithium-ion battery safety accidents are mainly caused by large current and high temperature generated by internal or external short-circuit of lithium-ion battery, which may cause combustion, explosion or other safety problems.

In the internal short-circuit of the lithium ion battery, the risk of short-circuit thermal runaway caused by the positive electrode current collector and the negative electrode active material layer is the greatest. The following methods are generally used to reduce the risk of the short-circuit: 1) lowering the possibility of short circuit caused by the positive electrode current collector and the negative electrode active material layer; 2) increasing the contact resistance when the positive electrode current collector and the negative electrode active material layer are short-circuited, thereby reducing the short-circuit current.

In the related art, a multi-layered positive electrode material is coated on the positive electrode current collector to construct an electrode of a multilayer structure, which may reduce the possibility of short-circuit caused by the positive electrode current collector and the negative electrode active material layer, and simultaneously reduce the current at the time of short-circuit. However, for the electrode of the multilayer structure (as shown in FIG. 1), the inner layer 20 usually adopts a positive electrode material with poor activity and high stability, and the outer layer 30 usually adopts a positive electrode material with better activity, so that the lithium ion battery fabricated by the electrode structure has a safety detection rate of nail penetrating, pressing, impacting, etc., which is significantly higher than that of the single-layer electrode structure, that is, the safety performance of the lithium ion battery is improved. However, due to the poor activity of the positive electrode material of the inner layer, the lithium ion battery has a cycle performance deteriorated after repeated charging and discharging, and the cycle performance and life thereof is significantly lower than that of the lithium ion battery adopting the single layer electrode structure.

### SUMMARY OF THE APPLICATION

In view of the above problems, the present application provides an electrode including a current collector, at least one surface of the current collector is coated with a first coating layer of a first active material; wherein the first coating layer includes at least one through hole, and the at least one through hole has a cross-sectional area of 1% to 20% of a cross-sectional area of the first coating layer.

In some embodiments of the present application, wherein the at least one through hole includes a first through hole and a second through hole, and the first through hole and the second through hole have a shape of at least one of circle, ellipse, or polygon.

In some embodiments of the present application, wherein the first through hole is spaced apart from the second through hole.

In some embodiments of the present application, wherein the electrode further includes a second coating layer coated with a second active material, the first coating layer is disposed between the second coating layer and the current collector, and the second coating layer is connected with the current collector through the at least one through hole.

In some embodiments of the present application, wherein one end of the first coating layer extends beyond the second coating layer in the length direction of the electrode.

In some embodiments of the present application, wherein one end of the first coating layer is aligned with the second coating layer in the length direction of the electrode.

In some embodiments of the present application, wherein one end of the second coating layer extends beyond the first coating layer in the length direction of the electrode.

In some embodiments of the present application, wherein the first coating layer has a thickness of 2 μm to 30 μm.

In some embodiments of the present application, wherein the cohesive force between the first coating layer and the current collector is greater than the cohesive force between the second coating layer and the current collector.

In some embodiments of the present application, wherein an electrical resistance of the first coating layer is greater than an electrical resistance of the second coating layer.

In some embodiments of the present application, wherein an activity of the second coating layer is greater than an activity of the first coating layer.

In some embodiments of the present application, wherein the current collector further includes an uncoated region disposed at both ends of or around the first coating layer.

The present application further provides a lithium ion battery including any one of the above electrode. In the lithium ion battery, the above electrode may be used alone as a positive electrode, or may be used as a negative electrode alone, and may also be used as a positive electrode and a negative electrode at the same time.

With the above technical solutions, the present application has the following beneficial effects:

By forming a first coating layer including at least one through hole on at least one surface of the current collector, and by providing a second coating layer on the first coating layer, the second coating layer may be connected with the current collector through the through hole, and the activity of the first coating layer is less than the activity of the second coating layer, so that compared to a lithium-ion battery with a single-layer electrode structure (i.e., only the second coating layer), the lithium ion battery prepared by using the electrode of the present application may improve the safety performance thereof, and has a significantly improved cycle life with respect to the lithium ion battery in which the multilayer electrode has the first coating layer without through hole. Therefore, the technical problem that the safety performance of the lithium ion battery using the multilayer structure electrode is improved but the cycle life is lowered may be well solved.

### BRIEF DESCRIPTION OF THE ACCOMPANYING DRAWINGS

FIG. 1 shows a cross-sectional view of an electrode having a conventional two-layer structure;

FIG. 2 is a top view showing an electrode coated with a first coating layer according to an embodiment of the present application;

FIG. 3A is a top view showing the first coating layer according to an embodiment of the present application;

FIG. 3B is a top view showing the first coating layer according to another embodiment of the present application;

FIG. 3C is a top view showing the first coating layer according to another embodiment of the present application;

FIG. 3D is a top view showing the first coating layer according to another embodiment of the present application;

FIG. 3E is a top view showing the first coating layer according to another embodiment of the present application;

FIG. 3F is a top view showing the first coating layer according to another embodiment of the present application;

FIG. 4 is a top view showing an electrode coated with a second coating layer according to an embodiment of the present application;

FIG. 5A is a cross-sectional view showing the electrode according to an embodiment of the present application;

FIG. 5B is a cross-sectional view showing the electrode according to another embodiment of the present application;

FIG. 5C is a cross-sectional view showing the electrode according to another embodiment of the present application;

FIG. 5D is a cross-sectional view showing the electrode according to another embodiment of the present application;

FIG. 5E is a cross-sectional view showing the electrode according to another embodiment of the present application;

FIG. 5F is a cross-sectional view showing the electrode according to another embodiment of the present application;

FIG. 6 is a cross-sectional view showing an electrode in which the current collector is coated with the first coating layer and the second coating layer on both surfaces according to an embodiment of the present application;

FIG. 7A is a cross-sectional view showing an electrode used as a positive electrode, and stacked or wound with a negative electrode and a separator according to an embodiment of the present application;

FIG. 7B is a cross-sectional view showing an electrode used as a negative electrode, and stacked or wound with a positive electrode and a separator according to an embodiment of the present application;

FIG. 7C is a cross-sectional view showing an electrode used as a negative electrode and a positive electrode, and stacked or wound with a separator according to an embodiment of the present application;

FIG. 8 is a view showing a gravure roll for coating the first coating layer of the electrode according to an embodiment of the present application;

FIG. 9 shows cycle life curves of lithium ion batteries of Examples 1 to 5 and Comparative Examples 1 to 2 according to the present application;

FIG. 10 shows cycle life curves of lithium ion batteries of Example 1 and Examples 6 to 10 according to the present application;

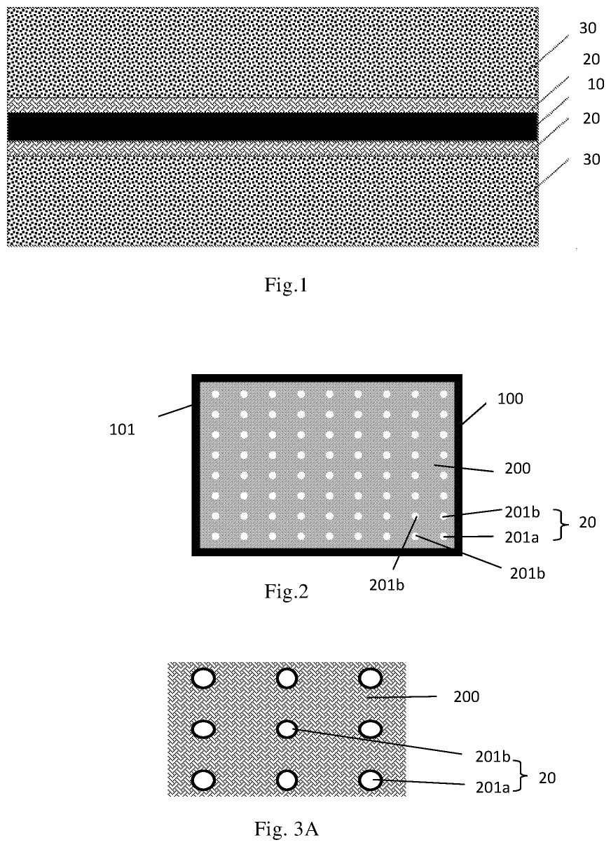

### REFERENCE NUMERALS

10—current collector; 20—inner layer; 30—outer layer; 40—non-recessed region;
100—current collector; 101—uncoated region; 200—first coating layer; 201—through hole, 201a—first through hole, 201b—second through hole;
300—second coating layer;
400—positive electrode, 401—positive electrode current collector, 402—positive electrode active material layer, 402a—first coating layer, 402b—through hole, 402c—second coating layer;
500—negative electrode, 501—negative electrode current collector, 502—negative electrode active material layer, 502a—first coating layer, 502b—through hole, 502c—second coating layer;
600—separator.

### DETAILED DESCRIPTION OF THE PREFERRED EMBODIMENTS

The following specific embodiments are provided to enable those skilled in the art to understand the present application more fully, but do not limit the application in any way.

The present application provides an electrode including a current collector 100, at least one surface of the current collector 100 is coated (including but not limited to coating, brushing, etc.) with a first coating layer 200 of a first active material (i.e., inner active material layer). The first coating layer 200 includes at least one through hole 201, and the at least one through hole 201 has a cross-sectional area of 1% to 20% of a cross-sectional area of the first coating layer 200.

It should be noted that the cross-sectional area ratio of the through holes 201 refers to those that are calculated by the total cross-sectional area of all the through holes 201 dividing by the cross-sectional area of the first coating layer 200 after subtracting the uncoated region 101 around the first coating 200 from the current collector 100. Among them, if the ratio of the cross-sectional area of the through hole 201 to the cross-sectional area of the first coating layer 200 is less than 1%, the improvement for cycle life is not obvious; if the ratio of the cross-sectional area of the through hole 201 to the cross-sectional area of the first coating layer 200 is greater than 20%, the improvement for the safety performance of lithium ion battery is not obvious.

In some embodiments, the at least one through hole 201 has a cross-sectional area of 1% to 15% of a cross-sectional area of the first coating layer 200. In some embodiments, the at least one through hole 201 has a cross-sectional area of 1% to 10% of a cross-sectional area of the first coating layer 200.

As shown in FIG. 2, the above at least one through hole 201 includes a first through hole 201a and a second through hole 201b. It should be noted that if one of the through holes 201 is defined as the first through hole 201a, the through holes 201 around the first through hole 201a may be defined as the second through hole 201b; similarly, the through holes 201 around the second through hole 201b may be defined as the first through hole 201a. In some embodiments, the first through hole 201a and the second through hole 201b may be spaced apart from each other, or one of the through holes 201 may be connected with the adjacent through hole 201 to form a through hole 201 having a larger cross-sectional area. In some embodiments, the first through hole 201a and the second through hole 201b may form an equally spaced array distribution, or an unequally spaced array distribution, and may also be other arrays, and the application is not limited thereto. In some embodiments, the shapes between the first through hole 201a and the second through hole 201b may be the same or different, and each of the first through hole 201a and the second through hole 201b may adopt at least one of a circular shape, an elliptical shape, or a polygonal shape.

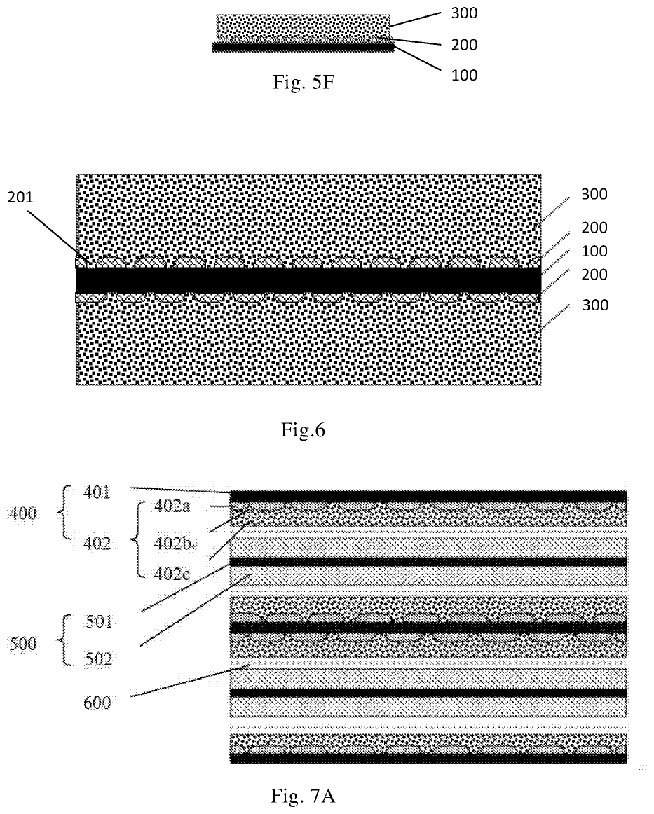

In some embodiments, the electrode further includes a second coating layer 300 (i.e., an outer active material layer) coated with a second active material, and a cross-sectional view thereof may be as shown in FIG. 6. The first coating layer 200 is disposed between the second coating layer 300 and the current collector 100, and the second coating layer 300 is connected with the current collector 100 through the at least one through hole 201 on the first coating layer 200.

The ratio of the cross-sectional area of the through hole 201 to the cross-sectional area of the first coating layer 200 may be regulated by the shape, the number, the size, the arrangement, and the like of the pattern of the through holes 201. When the cross-sectional area ratio of the through hole 201 is less than 1%, the improvement for cycle life is not obvious, and when the cross-sectional area ratio of the through holes 201 is greater than 20%, the improvement in the safety performance of the lithium ion battery is not obvious.

In some embodiments, the first coating layer 200 has a thickness of 2 μm to 30 μm. In some embodiments, the first coating layer 200 has a thickness of 5 μm to 20 μm. If the first coating layer is too thick, the migration rate of electrons may be limited and the performance of the electrode assembly may be deteriorated, and if the first coating layer is too thin, the safety performance of the lithium ion battery is not significantly improved.

In some embodiments, the first coating layer 200 has the following characteristics: (1) the first coating layer 200 and the second coating layer 300 are respectively coated on the current collector 100, and the cohesive force between the first coating layer 200 and the current collector 100 is greater than the cohesive force between the second coating layer 300 and the current collector 100; (2) the electrical resistance of the first coating layer 200 is greater than the electrical resistance of the second coating layer 300, wherein the electrical resistance of the first coating layer is greater than 10Ω/153.44 mm², and the electrical resistance of the second coating layer is less than 2Ω/153.44 mm²; (3) the activity of the first coating layer 200 is greater than the activity of the second coating layer 300, wherein the activity of the coating layer may be controlled by changing the kind of the active material, the content of the binder, and the content of the conductive agent. In general, the higher the binder content of the coating layer, the better the cohesive force, the lower the activity and the better the stability, however, excessive binder content may affect the diffusion of lithium ions and deteriorate the performance of the electrode assembly. In addition, the lower the content of the conductive agent contained in the coating layer, the lower the activity and the better the stability, and too little conductive agent content affects the migration rate of lithium ion in the electrode material, which in turn deteriorates the performance of electrode assembly. In some embodiments, the binder content of the first coating layer is 2% to 5%, and the binder content of the second coating layer is less than 2%.

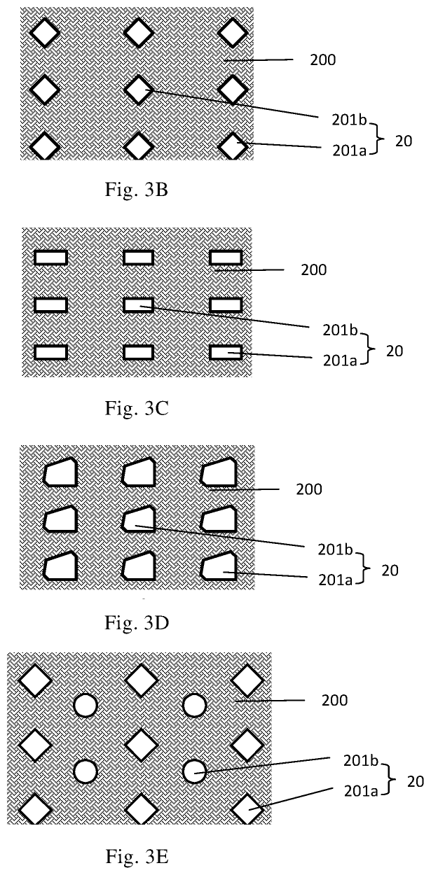

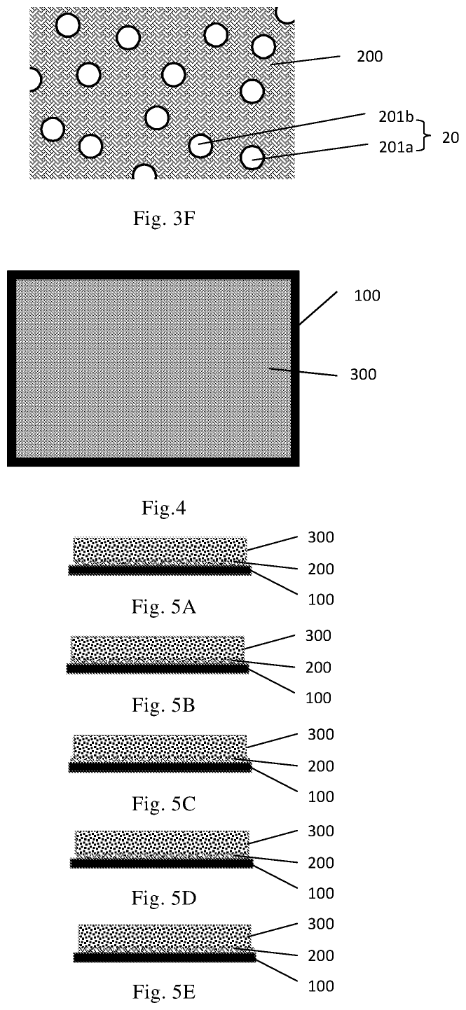

In some embodiments, the first coating layer 200 does not completely cover the current collector 100, that is, the first coating layer 200 is provided with at least one through hole 201, whose appearance is as shown in FIG. 2. Specifically, the through hole 201 of the first coating layer 200 may include a first through hole 201a and a second through hole 201b which are spaced apart from each other and uniformly distributed. The pattern of the region of the through hole 201 of the first coating layer 200 includes, but is not limited to, at least one of a circle, an ellipse, a polygon, and the like, such as the uniformly distributed circle shown in FIG. 3A, the square shown in FIG. 3B, the rectangle shown in FIG. 3C, the polygon shown in FIG. 3D, and the circle and square shown in FIG. 3E as well as the uniformly distributed circular shown in FIG. 3F, and the like.

The first coating layer 200 includes a first active material, a binder, a conductive agent, and the like. Among them, when the electrode is used as the positive electrode 400, the first active material of the first coating layer 402a may be a common positive electrode active material, for example, including at least one of lithium cobaltate (LCO), lithium iron phosphate, nickel cobalt manganese ternary material, and lithium titanate, and the like. The binder may be a common binder, for example, including at least one of polyethylene, polyvinylidene fluoride, polyvinylidene fluoride-hexafluoropropylene, polypropylene methyl methacrylate, polyacrylonitrile, polyethylene oxide, polypropylene oxide, and the like. The conductive agent may also be common conductive agent, for example, including at least one of conductive carbon black, carbon nanotube, acetylene black, conductive graphite, graphene, and the like. Some common chemical solvents may be used as the solvent, for example, the solvent including at least one of ethanol, acetone, methyl ethyl ketone, dimethylformamide, N-methylpyrrolidone, diethylformamide, dimethyl sulfoxide, tetrahydrofuran, and the like. The solvent is used to disperse the first active material, binder, and conductive agent to form a mixture, and then the mixture is coated on the positive electrode current collector 401 to form the first coating layer 402a.

In some embodiments, the second coating layer 300 of the electrode has a thickness of 20 μm to 100 μm, which has the following characteristics: (1) the outer coating layer is completely covering (i.e., completely covering the surface of the first coating layer 200), as shown in FIG. 4; (2) the activity of the second coating layer 300 is greater than the activity of the first coating layer 200.

The second coating layer 300 includes a second active material, a binder, a conductive agent, and the like. Among them, when the electrode is used as the positive electrode 400, the second active material may be a common positive electrode active material, for example, including at least one of lithium cobaltate, lithium iron phosphate, nickel cobalt manganese ternary material, lithium titanate, and the like. The binder may be a common binder, for example, including polyethylene, polyvinylidene fluoride, etc. The conductive agent may be some common conductive agents, for example, including at least one of conductive carbon black, carbon nanotube, acetylene black, conductive graphite, graphene, and the like. Moreover, some common chemical solvents may be used, such as N-methylpyrrolidone, diethylformamide, dimethyl sulfoxide, etc. The second active material, the binder, and the conductive agent are dispersed by the solvent to form a mixture and then the mixture is coated on the first coating layer 402a of the positive electrode current collector 401 to form the second coating layer 402c.

In some embodiments, in the length direction of the electrode, the length of the first coating layer 200 may be longer, equal to, or shorter than the length of the second coating layer 300. That is, in some embodiments and according to actual requirements, one end of the first coating layer 200 may be aligned with one corresponding end of the second coating layer 300 in the length direction of the electrode, then the other end of the first coating layer 200 may be beyond, aligned with or shorter than an end of the second coating layer 300 corresponding to the other end of the first coating layer 200, specifically, as shown in FIGS. 5B and 5E. In some embodiments, one end of the first coating layer 200 extends beyond the corresponding end of the second coating layer 300, then the other end of the first coating layer 200 may also be beyond, aligned with or shorter than an end of the second coating layer 300 corresponding to the other end of the first coating layer 200, specifically, as shown in FIG. 5C. Alternatively, one end of the second coating layer 300 extends beyond the corresponding end of the first coating layer 200, then the other end of the second coating layer 300 may also be beyond, aligned with or shorter than an end of the first coating layer 200 corresponding to the other end of the second coating layer 300, specifically, as shown in FIGS. 5A, 5D and 5F. And in some embodiments, the first coating layer 200 and the second coating layer 300 are mutually staggered, and in the length direction of the electrode, the amount of misalignment between the first coating layer 200 and the second coating layer 300 is 0 mm to 10 mm, and in some embodiments, the amount of misalignment thereof is 0 mm to 5 mm.

In some embodiments, the current collector 100 may also include an uncoated region 101. The uncoated regions 101 are disposed at both ends of or around the first coating layer 200 (as shown in FIG. 2 or FIG. 4). Both ends herein may refer to the starting and the trailing end of the current collector 100.

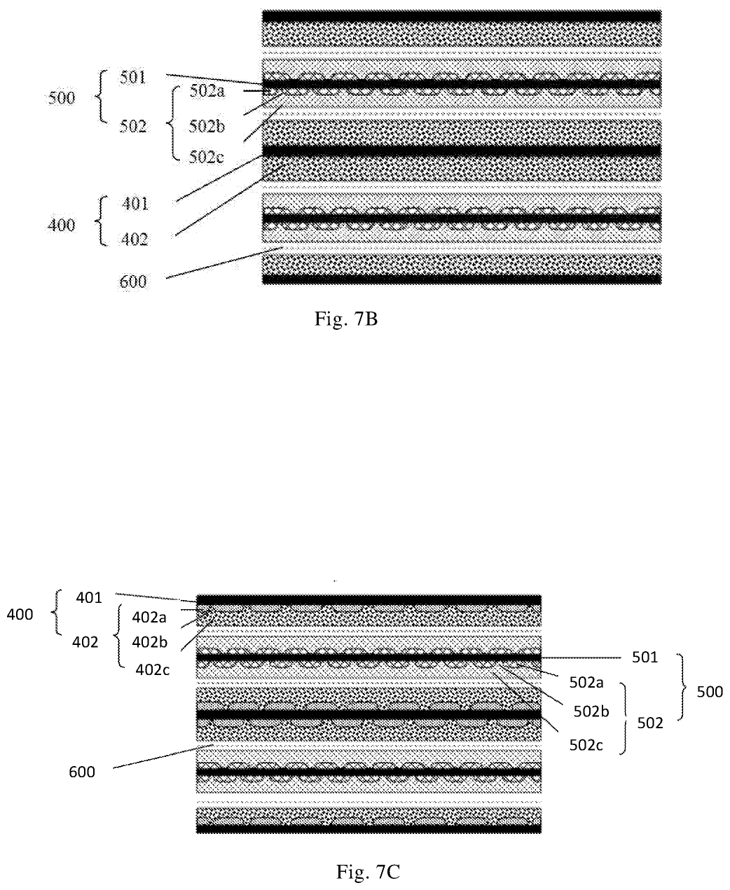

In some embodiments, the electrode is the positive electrode 400, and the current collector 401 is made of aluminum foil, the current collector 401 has a thickness of 10 μm. And the first coating layer 402a and the second coating layer 402c are coated on the surface of the current collector 401, such as the structure of the positive electrode 400 shown in FIG. 7A.

In addition, in some embodiments, some common coating methods may be employed to incompletely coat the first coating layer 200 on the surface of the current collector 100. The coating methods include, but are not limited to, gap block coating, continuous coating, continuous strip coating, and the like.

In some embodiments, the positive electrode 400 adopts an electrode structure having a two-layer structure (i.e., a first coating layer and a second coating layer) as described above, the negative electrode 500 has a single layer structure, then the electrode assembly is stacked or wound in the order of the positive electrode 400, the separator 600, and the negative electrode 500, and a cross-sectional view thereof is shown in FIG. 7A. Among them, the positive electrode 400 may include a positive electrode current collector 401 and a positive electrode active material layer 402, the positive electrode active material layer 402 may include first coating layer 402a and second coating layer 402c, and the first coating layer 402a of the positive electrode 400 is provided with at least one through hole 402b. The negative electrode 500 includes a negative electrode current collector 501 and a negative electrode active material layer 502.

In some embodiments, according to actual requirements, the above electrode structure may be used for the negative electrode 500, the positive electrode 400 adopts a single layer structure, and then the electrode assembly is stacked or wound in the order of the positive electrode 400, the separator 600, and the negative electrode 500, and a cross-sectional view thereof is shown in FIG. 7B. Among them, the positive electrode 400 may include a positive electrode current collector 401 and a positive electrode active material layer 402. The negative electrode 500 includes a negative electrode current collector 501 and a negative electrode active material layer 502, the negative electrode active material layer 502 may include first coating layer 502a and second coating layer 502c, and the first coating layer 502a of the negative electrode 500 is provided with at least one through hole 502b.

Further, in some embodiments, the above electrode structures may be simultaneously applied to the positive electrode 400 and the negative electrode 500 of the lithium ion battery, and then the electrode assembly is stacked or wound in the order of the positive electrode 400, the separator 600, and the negative electrode 500, and a cross-sectional view thereof is shown in FIG. 7C. Among them, the positive electrode 400 may include a positive electrode current collector 401 and a positive electrode active material layer 402, the positive electrode active material layer 402 includes the first coating layer 402a and the second coating layer 402c, and the first coating layer 402a of the positive electrode 400 is provided with the at least one through hole 402b. The negative electrode 500 includes a negative electrode current collector 501 and a negative electrode active material layer 502, the negative electrode active material layer 502 includes the first coating layer 502a and the second coating layer 502c, and the first coating layer 502a of the negative electrode 500 is provided with the at least one through hole 502b.

The preparation of the positive electrode 400 will be specifically described below, so that the present application may be better understood.

An aluminum foil is used as the current collector 401 of the positive electrode 400. Some common positive electrode active materials may be used as the first active material of the first coating layer 402a, for example, including at least one of lithium cobaltate, lithium iron phosphate, nickel cobalt manganese ternary material, or lithium titanate. The binder may adopt some common binders, for example, including at least one of polyethylene, polyvinylidene fluoride, polyvinylidene fluoride-hexafluoropropylene, polypropylene methyl methacrylate, polyacrylonitrile, polyethylene oxide or polypropylene oxide. The conductive agent may adopt some common conductive agents, for example, including at least one of conductive carbon black, carbon nanotube, acetylene black, conductive graphite or graphene. Some common chemical solvents may be used as the solvent, for example, including at least one of ethanol, acetone, methyl ethyl ketone, dimethylformamide, N-methylpyrrolidone, diethylformamide, dimethyl sulfoxide or tetrahydrofuran. The first active material, the binder and the conductive agent are placed in a mixer, stirred and mixed uniformly, and then the solvent is added to the mixer to disperse for uniformly stirring to prepare a slurry.

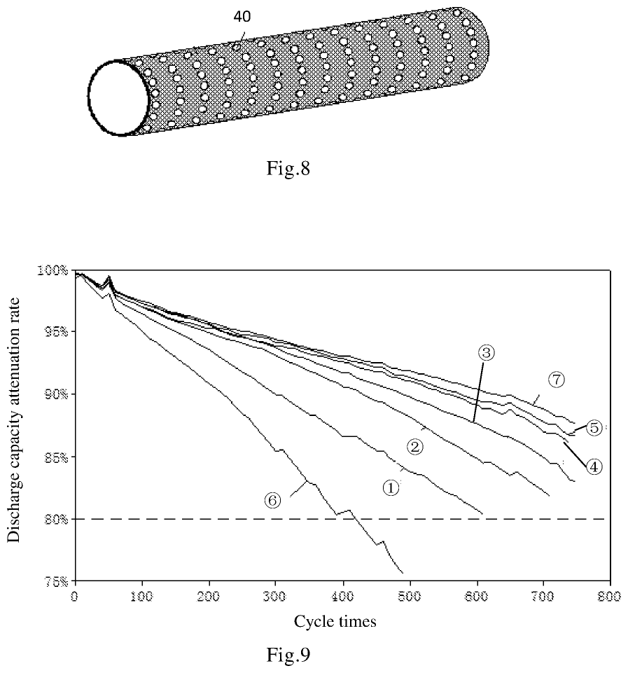

Next, a first coating layer 402a is prepared on the aluminum foil using a gravure roll (shown in FIG. 8) locally having a non-recessed region 40. That is, the gravure roll is partially immersed into the slurry tank, the gravure roll rotates to bring the slurry out, and after the slurry is scraped off by a blade, the slurry at the position where a recess is recessed in the gravure roll is retained in the recess while the slurry at the position of the non-recessed region 40 being scraped off. The gravure roll with the slurry is in contact with the current collector 401 and the slurry in the recess of the gravure roll is transferred to the current collector. However, since the slurry at the position of the non-recessed region 40 has been scraped off as it passes through the blade, the slurry may not be transferred, then the first coating layer 402a having at least one through hole 402b may be formed on the current collector 401. Thereafter, the current collector 401 with the first coating layer 402a is dried in an oven at a temperature of 90° C. to 120° C. to obtain the first coating layer 402a having an excellent cohesive force and a certain pattern.

Among them, the cross-sectional area of the at least one through hole 402b is 1%-20% of the cross-sectional area of the first coating layer 402a, and the first coating layer 402a may be continuous or discontinuous. The cross-sectional shape of the non-recessed region 40 may be at least one of a circle, an ellipse, or a polygon. And the cross-sectional shape of the through hole 402b formed by the non-recessed region 40 may also be at least one of a circular shape, an elliptical shape, or a polygonal shape, that is, the first coating layer 402a formed has a certain pattern. Among them, the coating method for the inner layer is not limited to the intaglio plate, and micro gravure, electrospray, transfer coating, extrusion coating, or the like may also be used. Further, the first coating layer 402a may be formed on the other surface of the current collector 401 in the same manner as described above (or formed only on one surface of the current collector 401).

The second coating layer 402c may also adopt some common positive electrode active materials, such as one or more of lithium cobaltate, lithium iron phosphate, nickel cobalt manganese ternary materials, or lithium titanate. It is also possible to adopt some common binders such as polyethylene, polyvinylidene fluoride, etc. Some common conductive agents may also be used, such as one or more of conductive carbon black, carbon nanotubes, acetylene black, conductive graphite, and graphene. It is also possible to adopte some common solvents such as one or more of N-methylpyrrolidone, diethylformamide, dimethyl sulfoxide, or tetrahydrofuran. The second active material, the binder and the conductive agent are placed in a mixer, stirred and mixed uniformly, and then the solvent is added to the mixer to disperse, and then the mixture is uniformly stirred to prepare a slurry. Thereafter, the second coating layer 402c is formed by extrusion coating, and gravure, micro gravure, electrospray, transfer coating, etc. may also be used; after the second coating layer 402c is formed, the current collector 401 having the second coating layer 402c is dried by using an oven of 90° C.-120° C. to obtain a uniform second coating layer 402c having excellent cohesive force.

Among them, the activity of the first coating layer 402a is less than that of the second coating layer 402c, that is, the stability is better, which is manifested in two aspects below: (1) the electrical resistance of the first coating layer 402a is greater than the electrical resistance of the second coating layer 402c; (2) the cohesive force of the first coating layer 402a is greater than the cohesive force of the second coating layer 402c.

In addition, in the length direction of the electrode, the length of the first coating layer 402a is shorter than, longer than or equal to the length of the second coating layer 402c, and the amount of misalignment between the first coating layer 402a and the second coating layer 402c may be in a range of 0 mm to 10 mm.

The preparation of the negative electrode 500 will be specifically described below, so that the present application may be better understood.

A copper foil is used as the current collector 501 of the negative electrode 500; graphite is used as the active material of the negative electrode active material layer 502, styrene-butadiene rubber and sodium carboxymethyl cellulose are used as the binder, and deionized water is used as the dispersing agent. The active material, the conductive agent, the binder and the dispersing agent are prepared to the slurry with the same stirring process as the stirring process for the first coating layer 402a described above, and dried in the same drying mode as drying the first coating layer 402a, to obtain a uniform active material layer 502 of the negative electrode 500.

The obtained positive electrode 400 and negative electrode 500 are rolled, cut, and welded with an electrode tab, and subjected to winding with the separator 600 disposed between the positive electrode 400 and the negative electrode 500, liquid injection and sealing, to form the lithium ion battery.

### Example 1

The first coating layer 402a of the positive electrode is incompletely coated and has a plurality of through holes 402b. A aluminum foil is used as the current collector 401 of the positive electrode 400.

Lithium iron phosphate is used as the main active material of the first coating layer 402a of the positive electrode 400, conductive carbon black is used as the conductive agent, polyvinylidene fluoride is used as the binder, and N-methylpyrrolidone is used as the dispersing agent. And the content ratio of lithium iron phosphate, conductive carbon black, polyvinylidene fluoride of the first coating layer 402a is 96.5:1:2.5. First, the active material, the conductive agent and the binder are uniformly mixed in a mixer, and then the above powders are dispersed by adding N-methylpyrrolidone, followed by adding a solution of pre-dissolved polyvinylidene fluoride in N-methylpyrrolidone and stirring, to obtain a slurry.

A gravure roll locally having the non-recessed region 40 (as shown in FIG. 8) is used to form the first coating layer 402a having a thickness of 10 μm on one surface of the current collector 401, then the current collector 401 coated with the first coating layer 402a is dried in an oven at a temperature of 90° C. to 120° C., wherein the first coating layer 402a has a plurality of spaced-apart and uniformly distributed through-holes 402b, and the cross-sectional area of the through hole 402b is 1% of the cross-sectional area of the first coating layer 402a. Among them, the cross-sectional shape of the non-recessed region 40 is circular, and the top view of the first coating layer 402a formed may be as shown in FIG. 3A. Further, the other surface of the current collector 401 is coated in the same manner to form the first coating layer 402a.

In the second coating layer 402c of the positive electrode 400, lithium cobaltate is used as the active material, conductive carbon black is used as the conductive agent, polyvinylidene fluoride is used as the binder, and N-methylpyrrolidone is used as the dispersing agent, to form a slurry, the content ratio of lithium cobaltate, conductive carbon black and polyvinylidene fluoride is 97.7:1:1.3. And the slurry is prepared by the stirring process similar to that of the first coating layer 402a described above.

The second coating layer 402c is continuously coated to both surfaces of the current collector 401 that has been coated with the first coating layer 402a, the second coating layer 402c is coated by extrusion coating, and the second coating layer 402c is dried in the same drying manner as drying the first coating layer 402a, to obtain the second coating layer 402c with a thickness of 70 μm.

A copper foil is used as the current collector 501 in the negative electrode 500. In the negative electrode 502, graphite is used as the active material, styrene-butadiene polymer solution, sodium carboxymethyl cellulose are used as the binder, and deionized water is used as the dispersing agent, the content ratio of graphite, styrene-butadiene polymer solution and sodium carboxymethyl cellulose is 97.2:0.8:1. The active material, the binder and the dispersing agent are prepared to the slurry with the same stirring process as the stirring process for the first coating layer 402a described above, and dried in the same drying mode as drying the first coating layer 402a, to obtain a uniformly coated active material layer 502 of the negative electrode 500.

The obtained positive electrode 400 and negative electrode 500 are rolled, cut, and welded with an electrode tab, and subjected to stacking or winding with the separator 600 disposed between the positive electrode 400 and the negative electrode 500, liquid injection and sealing, to form the lithium ion battery; the cross-sectional view of the electrode assembly thereof may be as shown in FIG. 7A.

### Example 2

It is the same as Example 1, except that the cross-sectional area of the through hole 402b is 5% of the cross-sectional area of the first coating layer 402a.

### Example 3

It is the same as Example 1, except that the cross-sectional area of the through hole 402b is 10% of the cross-sectional area of the first coating layer 402a.

### Example 4

It is the same as Example 1, except that the cross-sectional area of the through hole 402b is 15% of the cross-sectional area of the first coating layer 402a.

### Example 5

It is the same as Example 1, except that the cross-sectional area of the through hole 402b is 20% of the cross-sectional area of the first coating layer 402a.

### Example 6

It is the same as Example 1, except that the cross-sectional shape of the non-recessed region 40 is square, and the top view of the first coating layer 402a formed may be as shown in FIG. 3B.

### Example 7

It is the same as Example 1, except that the cross-sectional shape of the non-recessed region 40 is rectangle, and the top view of the first coating layer 402a formed may be as shown in FIG. 3C.

### Example 8

It is the same as Example 1, except that the cross-sectional shape of the non-recessed region 40 is polygon, and the top view of the first coating layer 402a formed may be as shown in FIG. 3D.

### Example 9

It is the same as Example 1, except that the cross-sectional shape of the non-recessed region 40 is circle and square, and the top view of the first coating layer 402a formed may be as shown in FIG. 3E.

### Example 10

It is the same as Example 1, except that the cross-sectional shape of the non-recessed region 40 is circle and irregularly arranged, and the top view of the first coating layer 402a formed may be as shown in FIG. 3F.

### Example 11

It is the same as Example 1, except that the first coating layer 402a has a thickness of 2 μm.

### Example 12

It is the same as Example 1, except that the first coating layer 402a has a thickness of 15 μm.

### Example 13

It is the same as Example 1, except that the first coating layer 402a has a thickness of 20 μm.

### Example 14

It is the same as Example 1, except that the first coating layer 402a has a thickness of 30 μm.

### Comparative Example 1

It is the same as Example 1, except that the first coating layer 402a does not have the through hole 402b.

### Comparative Example 2

It is the same as Example 1, except that the positive electrode 400 has a single active coating layer structure, and the specific preparation method is as follows:

lithium cobaltate is used as the positive electrode active material, conductive carbon black is used as the conductive agent, polyvinylidene fluoride is used as the binder, and N-methylpyrrolidone is used as the dispersing agent, the content ratio of lithium cobaltate, conductive carbon black and polyvinylidene fluoride is 97:1:2. The positive electrode active material, the conductive agent, the binder and the dispersing agent are prepared to the slurry with the same stirring process as the stirring process for the positive electrode first coating layer 402a described above, and dried in the same drying mode as drying the positive electrode first coating layer 402a. And then the other side of the current collector 401 is coated in the same manner, to obtain a positive electrode 400 coated with the active material layer 402 with a thickness of 70 μm.

Then, the lithium ion batteries prepared in the above Examples 1 to 15, and Comparative Examples 1 and 2 are subjected to a nail penetration performance test, a weight impact test, a side extrusion test, and a cycle performance test, and the specific test methods are as follows:

(1) Nail Penetration Performance Test

1. Charging the lithium ion battery to 4.2V-4.4V;

2. Penetrating the entire lithium ion battery with a steel nail having a diameter of 2.5 mm;

3. Measuring the temperature of the entire process and observing the phenomenon;

The standard for passing the nail penetration test is that the lithium-ion battery does not catch fire or explode.

(2) Weight Impact Test

1. Charging the lithium ion battery to 4.2V;

2. Installing a bar with a diameter of 15.8 mm and a weight of 9.1 kg in the center of the lithium ion battery;

3. Dropping from a height of (61±2.5) cm to impact the lithium ion battery;

4. Measuring the temperature of the entire process and observing the phenomenon;

The standard for passing the weight impact test is that the lithium-ion battery does not emit smoke, catch fire or explode.

(3) Side Extrusion Test

1. Charging the lithium ion battery to 4.2V;

2. Squeezing the lithium ion battery disposed between two planes and releasing when the applied force reaches 13 KN;

3. Measuring the temperature of the entire process and observing the phenomenon;

The standard for passing the side extrusion test is that the lithium-ion battery does not emit smoke, catch fire or explode.

(4) Cycle Performance Test

1. Sleeping for 5 minutes;

2. Charging the lithium ion battery to 4.2V with a constant current of 1.0 C, and then charging with a constant voltage until the current drops to 0.05 C, then stop charging;

3. Sleeping for 5 minutes;

4. Discharging the lithium ion battery to 3.0V with a constant current of 1.0 C;

5. Repeating above step 1 to step 4;

6. Stopping the test when the discharge capacity is lower than 80% of the initial discharge capacity twice in a row;

The standard for passing the cycle performance test is that the number of cycles of the lithium ion battery is greater than or equal to 300.

The test results of the above respective examples and comparative examples are shown in Table 1 below. For convenience of comparison, the results of Table 1 are shown in groups.

TABLE 1

| | | first coating layer | | | | | | |
|---|---|---|---|---|---|---|---|---|
| | | cross-sectional | | | nail | nail | | |
| | | area | shape | | penetration | penetration | weight | |
| | | percentage | of | | pass | pass | impact | side |
| | | of through | through | | rate | rate | pass | extrusion |
| Examples | electrode | hole | hole | thickness | (4.2 V) | (4.4 V) | rate | pass rate |
| 1 | positive | 1% | circle | 10 μm | 100% | 80% | 70% | 80% |
| | electrode | | | | | | | |
| 2 | positive | 5% | circle | 10 μm | 100% | 70% | 70% | 80% |
| | electrode | | | | | | | |
| 3 | positive | 10% | circle | 10 μm | 100% | 70% | 70% | 70% |
| | electrode | | | | | | | |
| 4 | positive | 15% | circle | 10 μm | 70% | 50% | 40% | 30% |
| | electrode | | | | | | | |
| 5 | positive | 20% | circle | 10 μm | 30% | 20% | 10% | 10% |
| | electrode | | | | | | | |
| 1 | positive | 1% | circle | 10 μm | 100% | 80% | 70% | 80% |
| | electrode | | | | | | | |
| 6 | positive | 1% | square | 10 μm | 100% | 80% | 70% | 70% |
| | electrode | | | | | | | |
| 7 | positive | 1% | rectangle | 10 μm | 100% | 70% | 60% | 70% |
| | electrode | | | | | | | |
| 8 | positive | 1% | polygon | 10 μm | 80% | 60% | 60% | 75% |
| | electrode | | | | | | | |
| 9 | positive | 1% | circle | 10 μm | 90% | 75% | 60% | 70% |
| | electrode | | and | | | | | |
| | | | square | | | | | |
| 10 | positive | 1% | irregularly | 10 μm | 95% | 70% | 60% | 75% |
| | electrode | | distributed | | | | | |
| | | | circle | | | | | |
| 11 | positive | 10% | circle | 2 μm | 70% | 50% | 40% | 60% |
| | electrode | | | | | | | |
| 1 | positive | 10% | circle | 10 μm | 100% | 70% | 70% | 80% |
| | electrode | | | | | | | |
| 12 | positive | 10% | circle | 15 μm | 100% | 80% | 80% | 80% |
| | electrode | | | | | | | |
| 13 | positive | 10% | circle | 20 μm | 100% | 90% | 90% | 90% |
| | electrode | | | | | | | |
| 14 | positive | 10% | circle | 30 μm | 100% | 90% | 90% | 90% |
| | electrode | | | | | | | |

Comparative Examples

| | | | | | | | | |
|---|---|---|---|---|---|---|---|---|
| 1 | positive | 100% | circle | 100 μm | 100% | 80% | 90% | 90% |
| | electrode | | | | | | | |
| 2 | positive | — | — | — | 20% | 0 | 0 | 10% |
| | electrode | | | | | | | |

As can be seen from Table 1, the positive electrodes 400 of Examples 1 to 5 are coated with a first coating layer 402a and a second coating layer 402c, and the first coating layer 402a has a plurality of through holes 402b. The pattern of the through holes 402b is a uniformly arranged circle, and the thickness of the first coating layer 402a is 10 μm. The cross-sectional area of the through hole 402b in the first coating layer 402a gradually increases in proportion to the cross-sectional area of the first coating layer 402a, which are 1%, 5%, 10%, 15%, and 20%, respectively.

Comparing Examples 1 to 5 and Comparative Example 1 with Comparative Example 2, it is understood that the adoption of the first coating layer 402a and whether or not the through hole 402b is provided may improve the safety performance of the lithium ion battery; this is because the cohesive force between the first coating layer 402a and the current collector is higher than that between the second coating layer 402c and the current collector, and the active material of the electrode under collision, extrusion or temperature change is not easily deformed and detached from the current collector, thereby avoiding direct short-circuit between the exposed positive electrode current collector and the active material layer of fully charged negative electrode, and improving the safety performance of the lithium ion battery. At the same time, the electric resistance of the first coating layer 402a is greater than that of the second coating layer 402c, and a large current is not easily generated upon internal short-circuit, thereby further improving the safety performance of the lithium ion battery.

Further, FIG. 9 shows the cycle life curves of the lithium ion batteries of Examples 1 to 5 and Comparative Examples 1 to 2 under normal temperature (25° C.) (wherein, \textcircled{1}—Example 1, \textcircled{2}—Example 2, \textcircled{3}—Example 3, \textcircled{4}—Example 4, \textcircled{5}—Example 5, \textcircled{6}—Comparative Examples 1, and \textcircled{7}—Comparative Example 2). With reference to FIG. 9, as can be seen from FIG. 9, the cycle performance of the lithium ion battery having the first coating layer 402a with the through hole 402b is superior to that of the lithium ion battery having the first coating layer 402a without the through hole 402b, and the larger the ratio of the cross-sectional area of the through hole 402b in the first coating layer 402a to the cross-sectional area of the first coating layer 402a, the better the cycle performance. Among them, the ratio of the cross-sectional area of the through hole 402b to the cross-sectional area of the first coating layer 402a may be regulated by the shape, the number, the size, the arrangement, and the like of the through holes 402b.

In summary, compared with the lithium ion battery of the conventional single-layer electrode, the lithium ion battery having a two-layer structure (i.e., the inner layer 20 and the outer layer 30 without the through holes 201) may be provided with a protective layer on the surface of the current collector without sacrificing or sacrificing the capacity of the lithium ion battery, so that the safety performance of lithium ion battery is improved, but their cycle performance will be significantly deteriorated. However, with the technical solution of the present application, a lithium ion battery adopting a two-layer electrode having a first coating layer 402a with the through hole 402b and a second coating layer 402c may improve the safety performance of lithium ion battery under the premise of ensuring the cycle performance of lithium ion battery. This is because the first coating layer 402a has the through hole 402b, and a portion of the second coating layer 402c may be connected with the surface of the current collector through the through hole 402b of the first coating layer 402a while the first coating 402a being capable of providing stable protection to the current collector, so that an additional current path is provided for the second coating layer 402c, the impedance of the lithium ion battery is lowered, the overall activity of the two-layer lithium ion battery is improved, and the performance deterioration rate of the lithium ion battery is reduced during charging and discharging, thereby improving the cycle performance thereof.

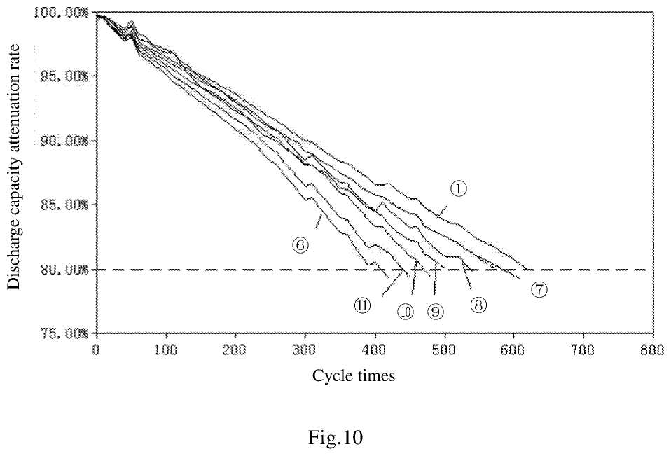

FIG. 10 shows the cycle life curves of the lithium ion batteries of Examples 1 and 6 to 10 under normal temperature (25° C.) (wherein, \textcircled{1}—Example 1, \textcircled{6}—Comparative Example 1, \textcircled{7}—Example 6, \textcircled{8}—Example 9, \textcircled{9}—Example 7, [symbol] —Example 8, and [symbol] —Example 10). As can be seen from FIG. 10, by changing the shape of the through hole 402b of the first coating layer 402a of the positive electrode 400 (such as circle, square, rectangle, polygon, circle and square, and irregularly distributed circle, etc.), it has a certain effect on the safety performance and cycle performance of lithium ion battery, but the effect is not significant.

Comparing Example 1 with Examples 11 to 14, it may be seen that as the thickness of the first coating layer 402a of the positive electrode 400 increases, the safety performance of the lithium ion battery fabricated therewith may also increase, but when the thickness is greater than 30 μm, it will be detrimental to the transportation of lithium ion and deteriorate the cycle performance of the lithium ion battery.

Those skilled in the art will appreciate that the above-described embodiments are merely exemplary examples, and various changes, substitutions and changes may be made on the technical solutions of the present application without departing from the spirit and scope of the present application, which still belongs to the scope of the present application.

What is claimed is:

1. An electrode, comprising:
a current collector, a first coating layer with a first active material is coated on at least one surface of the current collector;
wherein the first coating layer comprises at least one through hole, and the at least one through hole has a cross-sectional area of 1% to 20% of a cross-sectional area of the first coating layer.

2. The electrode according to claim 1, wherein the at least one through hole comprises a first through hole and a second through hole, and the first through hole and the second through hole have a shape of at least one of circle, ellipse, or polygon.

3. The electrode according to claim 2, wherein the first through hole is spaced apart from the second through hole.

4. The electrode according to claim 1, wherein the electrode further comprises a second coating layer coated with a second active material, the first coating layer is disposed between the second coating layer and the current collector, and the second coating layer is connected with the current collector through the at least one through hole.

5. The electrode according to claim 4, wherein one end of the first coating layer extends beyond the second coating layer in a length direction of the electrode.

6. The electrode according to claim 4, wherein one end of the first coating layer is aligned with the second coating layer in a length direction of the electrode.

7. The electrode according to claim 4, wherein one end of the second coating layer extends beyond the first coating layer in a length direction of the electrode.

8. The electrode according to claim 1, wherein the first coating layer has a thickness of 2 μm to 30 μm.

9. The electrode according to claim 4, wherein the cohesive force between the first coating layer and the current collector is greater than the cohesive force between the second coating layer and the current collector.

10. The electrode according to claim 4, wherein an electrical resistance of the first coating layer is greater than an electrical resistance of the second coating layer.

11. The electrode according to claim 1, wherein the current collector further comprises an uncoated region disposed at both ends of or around the first coating layer.

12. A lithium ion battery, comprising an electrode, the electrode comprising:
a current collector, a first coating layer with a first active material is coated on at least one surface of the current collector;
wherein the first coating layer comprises at least one through hole, and the at least one through hole has a cross-sectional area of 1% to 20% of a cross-sectional area of the first coating layer.

13. The lithium ion battery according to claim 12, wherein the at least one through hole comprises a first through hole and a second through hole, and the first through hole and the second through hole have a shape of at least one of circle, ellipse, or polygon.

14. The lithium ion battery according to claim 13, wherein the first through hole is spaced apart from the second through hole.

15. The lithium ion battery according to claim 12, wherein the electrode further comprises a second coating layer coated with a second active material, the first coating layer is disposed between the second coating layer and the current collector, and the second coating layer is connected with the current collector through the at least one through hole.

16. The lithium ion battery according to claim 15, wherein one end of the first coating layer extends beyond the second coating layer in the length direction of the electrode.

17. The lithium ion battery according to claim 15, wherein one end of the first coating layer is aligned with the second coating layer in the length direction of the electrode.

18. The lithium ion battery according to claim 15, wherein one end of the second coating layer extends beyond the first coating layer in the length direction of the electrode.

19. The lithium ion battery according to claim 12, wherein the first coating layer has a thickness of 2 μm to 30 μm.

20. The lithium ion battery according to claim 15, wherein the cohesive force between the first coating layer and the current collector is greater than the cohesive force between the second coating layer and the current collector.
